(19) United States
(12) Patent Application Publication
(10) Pub. No.: US 2014/0270110 A1
(43) Pub. Date: Sep. 18, 2014

(54) Systems and Methods for Cloud VoiceMail and Two Way Communication

(71) Applicant: AppForest LLC, Portland, ME (US)

(72) Inventors: Jeffrey L. Strunk, Eustis, ME (US); Urchie Bertram Ellis, JR., Atlanta, GA (US)

(73) Assignee: APPFOREST LLC, Portland, ME (US)

(21) Appl. No.: 14/213,963

(22) Filed: Mar. 14, 2014

Related U.S. Application Data
(60) Provisional application No. 61/790,022, filed on Mar. 15, 2013.

(51) Int. Cl. H04M 3/533

(52) U.S. Cl. CPC H04M 3/533
USPC 379/88.01; 379/88.22

(57) ABSTRACT

Systems and methods for cloud voicemail and two way communication. In some embodiments a method for providing answering service via an answering device comprises associating an answering service for a telephone number of a user with the answering device; enabling the answering device to receive at least one call targeted to the telephone number originating from a caller device; starting a call secession between the caller device and the answering device; responding to the call by sending to the caller device through the call session an answering message; detecting information related to an alternative communication channel different from the call session; and sending or receiving information via the alternative communication channel.

### RELATED APPLICATION

This application claims priority to the U.S. provisional patent application No. 61/790,022, filed on Mar. 15, 2013, and titled “AnswerApp,” the entire contents of which is incorporated herein by reference.

### TECHNICAL FIELD

The present disclosure relates generally to systems and methods related to telephone answering mechanisms and in particular to bi-directional telephone answering.

### BACKGROUND

Telecommunications answering machines are often hosted by a local exchange carrier (LEC). In order to have such answering machines activated, a business or individual must pay a monthly fee. A representative of the business or the individual accesses the answering machine by, for example, dialing a 10 digit number, navigating through prompt instructions, entering a personalized passcode, and then pressing a designated number to play back the answering machine messages. In order to record or change a message, or to change user options, the individual or business representative must follow additional prompts or procedures.

In some cases, LEC based answering machines may require the user to press up to about twenty button in order to simply update and record an outgoing message. In addition, if the user presses a button by mistake, the user may have to hang up and repeat the whole lengthy time-consuming process. In addition, current carrier based systems limit the number of incoming messages that can be stored. Thus, after a user reaches the limit, any caller attempting to leave a message receives a statement such as “This person's message mailbox is full, please call back later.” The system then terminates the call. Further, existing systems do not provide shortcuts for circumventing the answering machine's greeting and/or instructional prompts such that a user can expediently leave a message. Some carrier answering machines seem to deliberately insert lengthy instructions in order to increase the usage time, and thus the user's cost.

There is a need for an advanced answering system that avoids the above problems. Such an advanced answering system should further provide additional functionalities and the ease of use that today's users experience when utilizing other types of technology such as computers or smart phones.

### SUMMARY

In some embodiments a method for providing answering service via an answering device comprises associating an answering service for a telephone number of a user with the answering device; enabling the answering device to receive at least one call targeted to the telephone number originating from a caller device; starting a call secession between the caller device and the answering device; responding to the call by sending to the caller device through the call session an answering message; detecting information related to an alternative communication channel different from the call session; and sending or receiving information via the alternative communication channel.

According to some embodiments, detecting information related to an alternative communication channel includes detecting the type of the caller device and determining the alternative communication channel to be a communication method enabled by the caller device. According to some embodiments, detecting the type of the caller device includes detecting that the caller device is a smart phone and determining the alternative communication channel to be text messaging to the smart phone.

According to some embodiments, detecting information related to an alternative communication channel includes receiving the information related to the alternative communication channel from the caller device.

According to some embodiments, the alternative communication channel is an email address, an alternative telephone number, or a fax number.

According to some embodiments, a method for setting up answering service via an answering device comprises assigning a target telephone number to be serviced by the answering device; and assigning a call path to a call directed to the target telephone number. According to some embodiments, the target telephone number is a first telephone number and wherein the method further comprises assigning a second telephone number to be serviced by the answering device.

According to some embodiments, assigning the call path includes assigning one or more answering messages to the call directed to the target telephone number. According to some embodiments, assigning the call path includes assigning a plurality of answering messages to the call directed to the target telephone number, and wherein each of the plurality of the answering messages is used to answer the call based on a condition. According to some embodiments, the condition includes the date, the time of the day, the status of a business associated with the target telephone number, the origin of the call, or the type of the caller device.

According to some embodiments, the method further comprises assigning a condition for the call to be directed to the answering device. According to some embodiments, the condition includes that the target telephone number does not answer the call after a specified number of rings. According to some embodiments, assigning the call path includes associating an attachment with the mailbox of the target number. According to some embodiments, the method further comprises recording one or more answering voice message.

According to some embodiments, the method further comprises recording one or more answering voice message. According to some embodiments, the target telephone number is a first telephone number of a plurality of telephone numbers and the one or more answering voice message are a plurality of voice message, and wherein the method further comprises: assigning a second telephone number to be also serviced by the answering device; tying a first of the plurality of answering voice messages as the answering message to the first telephone number; and tying a second of the plurality of answering voice messages as the answering message to the second telephone number.

According to some embodiments, the one or more answering voice message are a plurality of voice message, and the method further comprises tying a first of the plurality of answering voice messages as the answering message to the telephone number when a condition is satisfied; and tying a second of the plurality of answering voice messages as the answering message to the telephone number when the condition is not satisfied, wherein the condition includes the date, the time of the day, the status of a business associated with the target telephone number, the origin of the call, or the type of the caller device.

In some embodiments, a telephone answering system comprises an answering device assigned for answering service for a telephone number of a user, wherein the answering device is configured to: receive at least one call targeted to the telephone number originating from a caller device, start a call secession between the caller device and the answering device, respond to the call by sending to the caller device through the call session an answering message, detect information related to an alternative communication channel different from the call session, and sending or receiving information via the alternative communication channel; and an answering server configured to store information related to the call, the answering message, or the information. In some embodiments, the answering device is a desktop computer, a laptop, or a smart phone. In some embodiments, the answering server is a desktop computer, a laptop, or a supercomputer.

### BRIEF DESCRIPTION OF THE DRAWINGS

The drawings are not necessarily to scale or exhaustive. Instead, emphasis is generally placed upon illustrating the principles of the embodiments described herein. The accompanying drawings, which are incorporated in this specification and constitute a part of it, illustrate several embodiments consistent with the disclosure. Together with the description, the drawings serve to explain the principles of the disclosure.

In the drawings:

FIG. 1 shows an answering system according to some embodiments.

FIG. 2 shows a flowchart for a system setup method according to some embodiments.

FIG. 3 shows a home screen display for an answering service according to an embodiment.

FIG. 4 shows a settings display for an answering service according to an embodiment.

FIG. 5 shows a recording display for an answering service according to an embodiment.

FIG. 6 shows a flowchart for a call flow according to some embodiments.

FIG. 7 shows a flowchart for a number set up method according to some embodiments.

FIG. 8 shows a flowchart for a method through which the answering device interacts with such a caller device interface.

FIG. 9 shows an example of a view that a caller may receive on the caller's device using the caller device interface.

### DETAILED DESCRIPTION

The following detailed description refers to the accompanying drawings. Wherever possible, the same or similar reference numbers are used in the drawings or in the description to refer to the same or similar parts. Also, similarly-named elements may perform similar functions and may be similarly designed, unless specified otherwise. Numerous details are set forth to provide an understanding of the described embodiments. The embodiments may be practiced without these details. In other instances, well-known methods, procedures, and components have not been described in detail to avoid obscuring the described embodiments.

While several exemplary embodiments and features are described here, modifications, adaptations, and other implementations may be possible, without departing from the spirit and scope of the invention. Accordingly, unless explicitly stated otherwise, the descriptions relate to one or more embodiments and should not be construed to limit the invention as a whole. This is true regardless of whether or not the disclosure states that a feature is related to “one,” “one or more,” “some,” or “various” embodiments. Instead, the proper scope of the invention is defined by the appended claims. Further, stating that a feature may exist indicates that the feature exists in one or more embodiments.

Various embodiments include an answering system that addresses the aforementioned problems of existing answering services and further adds several beneficial features, such a bi-directional communication between a caller and a receiver of the call.

FIG. 1 shows such an answering system 100 according to some embodiments. System 100 includes one or more caller devices 110 (labeled in FIG. 1 as caller 1 to caller m), one or more target devices 115, one or more answering devices 120 (labeled in FIG. 1 as answering device 1 to answering device n), and a server 130.

Caller device 110 is a device that a caller uses for calling a target number, such as a user's phone number. Upon doing so the call may first be directed to a target device 115 associated with the target number. Target device 115 may be, for example, the user's home phone or business phone. The user may have set up the answering system such that, after a specific event, the call is redirected from the user's target device to the user's answering machine. The specific event may include that, for example, the target device rings a pre-specified number of times and is not picked up. Alternatively, in some cases, the user may set up the answering system such that after the caller calls the target number, the call is immediately redirected to the answering machine. In various embodiments, the caller device may be a mobile phone using a wireless connection, a landline phone using a landline connection, or a VOIP dialer using an internet connection.

In some embodiments, each answering device 120 may provide an answering machine service for one or more target numbers of one or more users. A user may set up answering device 120 to act as an answering machine for one or more of the phone numbers used by the user. The user, for example, may set up a smart phone or a laptop to answer incoming calls to the user's home phone number and one or more business numbers. In some embodiments, answering device 120 may be a mobile device or a computer such as a laptop or a desktop. In some embodiments, answering device 120 may include one or more processors performing the processes detailed herein. In some embodiments, answering device 120 may be a smartphone executing a mobile application (“app”) that performs the functionalities described herein.

In some embodiments, the connection between the caller device and the answering device is bidirectional. That is, the caller's message on the answering device may trigger receiving some follow up information or documents from then answering device. In some embodiments, the target device and the answer device are both included in the same device. For example, in some embodiments, the caller calls the user's smartphone and is directed to the answering service, also installed on the same smart phone. The user may set up the answering service of the user's smartphone to answer to calls made to the smartphone as well as calls made to one or more other phones.

In some embodiments, the answering system is set up such that when a caller calls the target device, the call is first directed to the answering device. The answering device may then redirect it to the target device. Alternatively, the answering device may direct the call to a voicemail. This could happen when, for example, a business target has set up the answering service to direct the callers to the voicemail without any rings during the closed hours of the business.

Server 130 interacts with answering devices 120. In particular, server 130 includes a database for storing information related to the answering service provided by answering devices 120. In various embodiments, server 130 may include a computer, such as laptop or a desktop, a specialized processor, a multi-processor, or a network of one or more processors. Moreover, server 130 may include one or more data storage systems, databases, and communication interfaces for performing the functions detailed herein. The server may maintain a backup copy of data on one or more answering devices; store voicemails and other information related to calls received by one or more answering devices; provide supplemental storage to the answering devices, for storing incoming voicemail and messages, or prior answering messages for future re-use; communicate text messages from customers; and manage communications between different devices such as answering devices or caller devices.

FIG. 2 shows a flowchart for a system setup method 200 according to some embodiments. A user may perform method 200 in interaction with an answering device for setting up the answering device as an answering machine for one or more of the user's phone numbers. In some of the shown embodiments, such as the one in FIG. 2, the answering service is called AnswerApp.

FIG. 3 shows a home screen display 300 for an answering service according to an embodiment. In FIG. 3, the answering service is AnswerApp. Home screen 300 allows the user to access the user's incoming messages in the Inbox; set up answer paths or call paths, as detailed below; access media library, detailed below; and set up the answering device. Home screen 300 further allows the user to access voicemails in two of the user's voicemail boxes, here related to the user's business and personal phone numbers. In some embodiments, home screen display 300 is the first screen that the user receives when the user opens an answering service application on a computer or a smart phone.

Returning to setup method 200 of FIG. 2, in block 202 the user selects an option for setting up the device. The answering device may present to the user one or more different setup options. These setup options may include recording one or more messages (210), attachment association (220), call path assignment (230), assign number of rings (240), and telephone number setup (250).

FIG. 4 shows a settings display 400 for an answering service according to an embodiment. Settings display 400 provides to the user options for viewing and modifying telephone settings and account settings. In particular, telephone settings include options related to displaying phone number, adding more extensions, number of rings for pickup, and personal voicemail box.

Returning to block 210 of FIG. 2 for recording one or more messages, in decision block 212 the device inquires whether the user wants to record and playback a single message or multiple messages for the answering service. If the user selects a single message, in block 214 the user can record and store the message. In various embodiments, the message may be stored on the answering device or on the server. Similarly, if the user selects multiple messages, the user can record and store those multiple messages. In some embodiments, the user may also modify existing messages. For example, in blocks 216-218, the user selects one or more messages and modifies them. In some embodiments, the user modifies a message by replacing it with a new message. In some embodiments, a user modifies a message by clipping some sections of it or by appending to it parts of another recorded message. For example, a user may record a general greeting related to the business or to an occasion and append it to the beginning of several answering messages for different departments or extensions.

FIG. 5 shows a recording display 500 for an answering service according to an embodiment. Recording display 500 provides to the user options for recording, re-recording, and deleting a voice message. Moreover, the system allows the user to tie the voice message to a special occasion, date, range of dates, or times of day. In FIG. 5, for example, the voice message relates and is tied to the Thanksgiving Day. The user, thus, can set up the system to use this message on, for example, the Thanksgiving Day.

Returning to block 230 of FIG. 2 for call path assignment, in blocks 232-234, the device builds system messages and assigns them to one or more mailboxes set up in the answering device. An answering device may service more than one mailbox. Each mailbox may correspond to, for example, one of the phone numbers serviced by the answering device.

If the user chooses to assign number of rings (block 240), in block 242 the device may set that number based on an input from the user.

If the user chooses to set up telephone numbers for the one or more mailboxes (block 250), in blocks 251-255 the system receives and sets one or more phone numbers or extension numbers. The system may further associate those numbers or extensions with one or more mailboxes or call paths, as detailed below.

In various embodiments, the system sets one or more call flows for calls received by one or more target devices and directed to the answering device. FIG. 6 shows a flowchart for a call flow 600 according to some embodiments. Call flow 600 defines a set of steps taken when a call received by a specific business number. Call flow 600 may only apply to calls made to a specific target device or during specific times.

In block 602, the caller dials the phone number of the business. In the embodiment shown, the call is first directed to the answering device. In block 604, the answering device receives the identification of the target number from the call and dials the ghost line or extension associated with the target number.

In decision block 606, the system determines whether the target device is picked up within the designated time or number of rings. If it is picked up (block 608), the call flow ends.

If, on the other hand, the target device is not picked up, a call session starts between the answering device and the caller device. The call session includes the following set of interactions between these device and thorough the established telephone connection. In decision block 610, the answering device may choose one of multiple possible call paths at this junction. These call paths may include, for example, a shortcut to the voicemail box or listening to the greeting and further options. In some embodiments, the answering device presents these options to the caller and allows the caller to choose one by, for example, pressing a button or stating an option. In some embodiment, the call path is selected by the system based one or more conditions, such as the time of the day, the date (such as specific holidays), or the state of a business (for example, when a restaurant is at full capacity).

If, for example, the shortcut option is selected (block 612), the caller is directed to the voicemail box (block 616), and the call ends after the caller leaves a voicemail (block 620). If, on the other hand, the greeting option is selected, in block 614 the answering device announces to the caller a greeting message. The greeting message, itself, may change based on the target number or extension, date or time, or state of the business, or other conditions. The greeting may also end by letting the caller chose one or more options by pressing one or more keys.

In decision block 618, the system determines the next step based on the selection of the caller. The caller may, for example, select leaving a voicemail (block 616), ending the call by selecting a corresponding option or simply hanging up (620).

The caller may also select receiving some additional information in the form of, for example, a text, a URL, a voice message, a display, or an attachment (block 622). In some cases, for example, the answering service of a business may offer the caller receiving the brochure, menu list, or program list of the business. The service may further ask the caller to provide a means for receiving the additional information. The caller may, for example, select receiving the information or documents via audio message read back to the caller, a fax sent back to the caller's fax machine, a document emailed back to the user's email address, a display message or document sent to the user's email address or smart phone, or a text message sent to the user's smart phone or other devices. The caller may further provide the details of the connection for the means, such as, the email address, smart phone number, or fax number. The caller may provide this information by voicing it in the system. The system may then use a voice recognition technique to interpret that information and use it.

Alternatively, the caller may enter this information using the phone's keypad, or more advanced entry options if the caller is using, for example, a smart phone. As part of the interaction, the answering device may ask the caller to identify the type of the caller device (such as traditional phone, smart phone, or VOIP dialer) to accordingly send and receive information in a compatible format (e.g., voice for traditional phone or VOIP phone, or text message for a smart phone).

Alternatively, in some embodiments, the system detects the type of the caller device and accordingly sends the information or documents back to the caller device in a manner that fits the capabilities of that device. The system may, for example, detect that the caller device is a wireless device or a smartphone, and thus send the information via text message or media files that such smart phones can handle. Alternatively, the system may detect that the caller device is not a wireless device and instead send the information via an audio message.

In block 624, the system uses the above information to send the caller the additional information via the means that the caller provided.

In some embodiments, the user can set up for the answering system to associate one or more attachments with one or more of the answering messages. A user may, for example, associate a menu document with an answering message to calls made to the user's restaurant. Or a user may associate a program list with an answering message to calls made to the user's music club. The answering message may propose the attachment to the caller and if the caller requests it, and send the attachment to the caller via one or more of the mechanisms detailed above. These mechanisms may include emailing, faxing, or texting the document or information in the attachment.

In various embodiments, the system associates one or more target numbers with a call flow. FIG. 7 shows a flowchart for a number set up method 700 according to some embodiments. In block 702, the user may select setting up the numbers from the setup menu.

In block 704, the system receives a business phone number, for example. In block 706, the system receives a ghost or an extension number. In block 706, the system sets a number of rings for the target number. In some embodiments, the user enters the business number, ghost or extension number, or the number of rings, during the set up process.

Some embodiments further provide a caller device interface for the user to facilitate the interaction between the caller device and the answering device. In some embodiments, such an interface enables the caller to send back different types of information to the answering device. FIG. 8 shows a flowchart for a method 800 through which the answering device interacts with such a caller device interface. In the embodiment shown in FIG. 8, the caller device interface is called the AnswerApp viewer. In some embodiments, the caller device interface is a smart phone or a computer equipped with an application for interacting with the caller device in the manner examples of which are detailed below.

In block 802, the answering device prepares outbound information to be sent to the caller device. In various embodiment, this information may include, for example a text message, an MSS message, a voice message, a video clip, another type of a media file, a document.

In block 804, the system determines whether AnswerApp viewer is installed on the caller device. The system may do so by directly asking the caller, or checking the configuration of the caller device, or checking the installed hardware or software on the caller device.

If the viewer is not installed on the caller device, in block 806 the answering device sends the caller device a means for the caller to install the viewer. This means may include a web link to a webpage associated with the viewer, an FTP site, or a light version of the executable for the viewer.

In decision block 808, the system asks the caller whether the caller wishes to install the viewer. If the caller does not wish to do so (block 810), the system may send the information via means that are usable by the caller device (such as voice or video for a smart phone) and end the process.

If, on the other hand, the caller elects installing the viewer, in block 812 the caller device receives and installs the viewer.

Once the caller device is enabled with the viewer for the first time, or if it already installed (block 814), the caller may use the viewer to receive and view the information sent by the answering device. Moreover, the answering system may ask the caller whether the caller intends to send back to the answering device any information (block 816). If so, in block 818, the caller selects the type of that information, e.g., text, voice, document, video, and sends it to the answering device.

Some embodiments enable a text messaging feature. If activated, this feature allows an attachment, such as a brochure, to be sent to a caller by having the caller press a designated key stated in the recorded message. The embodiment allows a user to have a multitude of prompts for different documents including, but not limited to, business schedules, brochures, price lists, menus, wedding announcements, or photos.

In some embodiments, the system detects the type of the caller device and accordingly provides options that fit the capabilities of the caller device. The system may, for example, detect that the caller device is a wireless device or a smartphone, and thus provide options that include exchanging text message or media files that such smart phones can handle. Alternatively, the system may detect that the caller device is not a wireless device and instead present options that does not include those options, but still include exchanging voice messages or fax number via voice.

FIG. 9 shows an example of a view 900 that a caller may receive on the caller's device using the caller device interface. View 900 shows a schedule and offerings of a business on different dates. A user may subsequently choose one of the offered programs and book that program by calling back the business's number and leaving a message on the answering device. Alternatively, a caller may leave a voice message on the business's answering device using the viewer. The viewer will directly interact with the answering device without a need for the caller to call back. The caller may thus record a voicemail or draft a text message, requesting a reservation, and send that to the answering device via the viewer. The business can thus receive that message via the answering device and accordingly make the reservation for the caller and possibly send back a response, confirming the reservation.

Several embodiments provide on board smart phone application (“app”), which enables the smart phone to function as an answering machine for a business user or an individual user. In some embodiments, the app is called an AnswerApp. In some embodiments, when a caller calls one of the user's one or more phone numbers, the incoming call may be routed through the smart phone running the app. The smart phone receives the call and transfers it to a line that calls the corresponding target, e.g., the user's home or business. The phone rings at the target for a designated number of rings and, if not picked up, the smart phone transfers the caller to an answering system related to the target phone, in the manner detailed below.

The AnswerApp technology, that is, an answering device equipped with the AnswerApp application, may require the business or individual user to have two telecommunication lines. The phone number which individuals call to reach a user is entered into the AnswerApp user option field named “enter incoming number,” the user then enters the line 2 into the user option field named “enter outgoing number”.

By using two-line concurrent mobile technology, where two numbers can be received on a smart phone, AnswerApp may receive the call and then dial a ghost or additional phone number, or VOIP or other, which rings the business's or individual's number. The business or individual user sets the desired number of rings to ring at the place of business or home. If there is no answer, AnswerApp picks up the call and takes over as the answering machine, which allows the calling party to activate or use the features described in these claims.

To record an outgoing message using AnswerApp, a user opens the application and chooses “record out going message or greeting” presses record, and then either saves, or discards and re-records the outgoing message. The user can record greetings or announcements for multiple days and set each greeting or message to activate at a specified date and time.

After the user prescribed number of rings, the answering machine greeting is activated, without the carrier intervention of message statements that can't be turned off.

AnswerApp may be located on the user's smart phone; no number is required to call in to an LEC. AnswerApp may allow the addition of short cuts that circumvent announcements and allows a caller to go directly to leave a message. AnswerApp allows as many voice messages as the smart phone has memory for, virtually eliminating the problem of having a full voice mailbox. AnswerApp allows voice messages to be translated to print and to be forwarded via SMS or e-mail, or to be printed out. AnswerApp user options are streamlined allowing a user to record a message without having to dial into a system or be annoyed by numerous prompts. AnswerApp simplifies and gives immediate access for a user to record and update an outgoing message from anywhere in the world. AnswerApp allows a user to add one or more extensions.

AnswerApp also allows a user to cut and paste portions of, or all of, a previously recorded message to other extensions to create or modify outgoing messages for those extensions. AnswerApp allows a user the option to edit a recorded message and add music, using editing tools which would allow for layering music over the recorder's voice, or fade in and fade out, as well as standard equalizer controls and volume levels a standard recording program might have.

Additional technology allows for text messaging. If activated, this feature allows an attachment such, as a brochure, to be sent to a caller by having the caller press a designated key stated in the recorded message. The app allows a user to have a multitude of prompts for different documents including, but not limited to: band schedules, brochures, price lists, menus, wedding announcements, or photos.

AnswerApp allows a user access to a list of callers, and to the data associated with incoming messages; such as caller ID, time and duration. AnswerApp will display on the smart phone icon how many messages are stored in the answering machine. AnswerApp user options allow a user to add ring tones to incoming messages and individual phone numbers.

AnswerApp can be set to “automatic pickup” instead of ringing the business. For larger businesses AnswerApp will allow a caller to hear an automated announcement and choose.

In various embodiments, one or more of modules or devices disclosed in this disclosure are implemented via one or more software programs for performing the functionality of the corresponding modules or via computer processors executing those software programs. In some embodiments, one or more of the disclosed modules are implemented via one or more hardware modules executing firmware for performing the functionality of the corresponding modules. In various embodiments, one or more of the disclosed modules include storage media for storing data used by the module, or software or firmware programs executed by the module. In various embodiments, one or more of the disclosed modules or disclosed storage media are internal or external to the disclosed systems. In some embodiments, one or more of the disclosed modules or storage media are implemented via a computing “cloud”, to which the disclosed system connects via a network connection and accordingly uses the external module or storage medium. In some embodiments, the disclosed storage media for storing information include non-transitory computer-readable media, such as a CD-ROM, a computer storage, e.g., a hard disk, or a flash memory. Further, in various embodiments, one or more of the storage media are non-transitory computer-readable media store information or software programs executed by various modules or implementing various methods or flow charts disclosed herein.

The foregoing description of the invention, along with its associated embodiments, has been presented for purposes of illustration only. It is not exhaustive and does not limit the invention to the precise form disclosed. Those skilled in the art will appreciate from the foregoing description that modifications and variations are possible in light of the above teachings or may be acquired from practicing the invention. For example, the steps described need not be performed in the same sequence discussed or with the same degree of separation. Likewise various steps may be omitted, repeated, or combined, as necessary, to achieve the same or similar objectives. Similarly, the systems described need not necessarily include all parts described in the embodiments, and may also include other parts not described in the embodiments. Accordingly, the invention is not limited to the above-described embodiments, but instead is defined by the appended claims in light of their full scope of equivalents.

1. A method for providing a voice mail service, the method comprising:
associating a first telephone line with a mobile device, the first telephone line being at least one of a plurality of secondary lines of the mobile device;
providing a software application for receiving at least one communication session corresponding to the first telephone line;
routing the at least one communication session to a second telephone line, the second telephone line corresponding to a business or home of the user of the mobile device; and
activating a voicemail service via the software application to store voice messages by a caller initiating the at least one communication session in response to a reaching predetermined number of rings at a terminal of the second telephone line, wherein the software application stores the voice messages on a memory of the mobile device.

2. The method of claim 1 further comprising:
associating the first telephone line with the software application by linking a telephone number corresponding to the first telephone line with an incoming number field of a voice message management system interface of the software application ; and
associating the second telephone line with the software application by linking a telephone number corresponding to the second telephone line with an outgoing number field of a voice message management system interface of the software application.

3. The method of claim 1 further comprising:
providing a recording interface, via the software application, configured to receive at least one greeting and/or announcement to be recorded, the recording interface
including a calendaring tool enabling a user to associate each of the at least one greeting and/or announcement with an activation time.

4. The method of claim 3 wherein the activation time identifies a date, time, and/or duration for which the at least one greeting and/or announcement is to be presented to a caller.

5. The method of claim 1 further comprising:
enabling the user to define each state of an interactive voice response (IVR) system corresponding to the voice mail service; and
enabling the user to define at least one communication pathway between each state of the IVR.

6. The method of claim 5 further comprising:
providing a caller with short cuts by which to circumvent at least one state of the IVR system.

7. The method of claim 1 further comprising:
enabling the user to print, SMS, and/or email transcribed voice recordings.

8. The method of claim 1 further comprising:
enabling the user to route the at least one communication session to a third telephone line; and
enabling the user to add additional telephone lines to which the at least one communication session can be routed.

9. The method of claim 1 further comprising:
providing the user with a greeting creation interface, the greeting creation interface enabling the user to cut and paste portions of, or all of, at least one previously recorded message to create a new message;
the greeting creation interface further configured to enable the user to edit a recorded message, wherein editing includes at least one of layering musing, fading, equalizing, changing volume levels of recordings.

10. The method of claim 1 further comprising:
providing the caller with content via SMS or email in response to the caller pressing a designated key indicating an acceptance by the caller to receive the content, the content including at least one of band schedules, brochures, price lists, menus, wedding announcements, and photos.

11. The method of claim 10 further comprising:
providing an interface to the caller, the interface enabling the caller to input information corresponding to a communication medium by which the caller wishes to receive the content.

12. The method of claim 1 further comprising:
providing a user with a database of a plurality of pre-recorded greetings for the voice mail service; and
charging the user a fee for utilizing at least one of the plurality of pre-recorded greetings for the voice mail service.
